(19) United States
(12) Patent Application Publication
(10) Pub. No.: US 2008/0189791 A1
(43) Pub. Date: Aug. 7, 2008

(54) Device running with embedded software and method for verifying embedded software license

(75) Inventors: Kenichiro Yamato, Yokohama (JP); Yohji Tanaka, Ebina (JP); Yuji Kobayashi, Hadano (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/012,906

(22) Filed: Feb. 5, 2008

(30) Foreign Application Priority Data
Feb. 7, 2007 (JP) 2007-027871

(51) Int. Cl. G06F 21/00

(52) U.S. Cl. 726/26

(57) ABSTRACT

A device running with embedded software directly verifies the license of software to be executed in the device in order to prevent illegal copy and use of the embedded software. The device running with embedded software includes an information storage unit for storing the hardware specific information, and a verification function unit for determining the validity of the license information. The verification function unit includes a license information reception unit for receiving the license information, and a hardware specific information acquisition unit for acquiring the information from the information storage unit. The verification function unit determines, in a license verification unit, the validity of the license by matching the acquired hardware specific information with the hardware specific information included in the received license information.

### BACKGROUND OF THE INVENTION

The present invention relates to a device running with embedded software, and more particularly to a technology for preventing illegal copy and use of the embedded software.

Prevention of illegal use of software relies on the user to input license information. The software runs normally only when the input license information is correct. Alternatively, as disclosed in JP-A No. 2005-189913, when software is activated in a device such as PC with the software installed therein, the activation is allowed when the serial number of the software, the MAC (Media Access Control) address allocated to the PC, and other information are transmitted to a license management server.

### SUMMARY OF THE INVENTION

In the method for inputting the license information, the user is not allowed to use the software unless knowing the license information. However, the user can use it by illegally acquiring the license information. The software license verification guarantees the correctness of the license, but does not involve determining whether the correct license information is normally purchased or illegally copied. For this reason, once a single software application and single license information are acquired, it is possible to use them in plural hardware platforms at the same time.

In the case of JP-A No. 2005-189913, the activation is allowed only when the predetermined information is transmitted through a network. However, the method does not take into account the load on the entire network such as when a large number of users activate the software at the same time.

The present invention aims at providing a device running with embedded software, which is allowed to perform license verification to prevent illegal copy and use of the embedded software.

In order to achieve the above object, the present invention provides a device running with embedded software, which includes an information storage unit for storing hardware specific information, and a verification function unit for determining the validity of the license information. The verification function unit includes a license information reception unit for receiving the input of the license information, a hardware specific information acquisition unit for acquiring information specific to the hardware from the information storage unit, and a license verification unit for determining the validity of the license by matching the acquired hardware specific information with the hardware specific information included in the received license information.

Preferably, the device running with embedded software according to the present invention includes a function for acquiring the hardware specific information stored in the device, a function for receiving and decrypting encrypted license information including the hardware specific information, and a function for matching the hardware specific information included in the decrypted license information with the hardware specific information stored in the device.

According to the present invention, a single embedded software application is only allowed to be used in a single hardware platform corresponding to each license, thereby preventing the embedded software from being illegally used, even if a malicious user copies the embedded software and fabricates the license information.

### BRIEF DESCRIPTION OF THE DRAWINGS

FIG. 1 is a diagram showing the configuration of a device running with embedded software, which is an embodiment of the present invention;

FIG. 2 is a block diagram showing the functional configuration of a verification function unit 17 of FIG. 1 for determining the validity of the license information, as well as the functional configuration of a license information generator 24 of FIG. 1;

FIG. 3 is a diagram showing the reception of the license information via the Internet;

FIG. 4 is a diagram showing the transmission of the hardware specific information via the Internet;

FIG. 5 is a functional block diagram of a server which is an example of the device running with embedded software of FIG. 1;

FIG. 6 is a diagram showing the configuration of BMC; and

FIG. 7 is a diagram showing the content of the license information.

### DETAILED DESCRIPTION OF THE INVENTION

In the following, a specific embodiment of the present invention will be described with reference to the accompanying drawings.

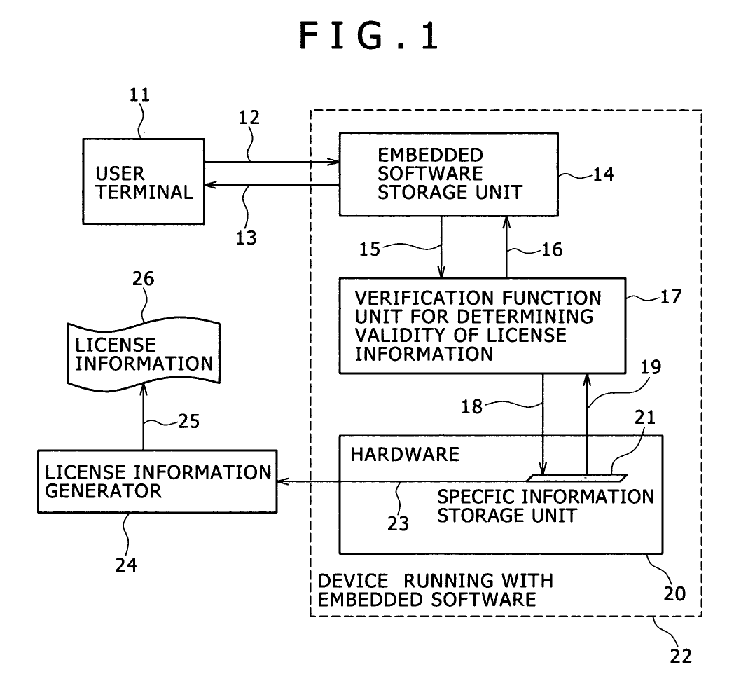

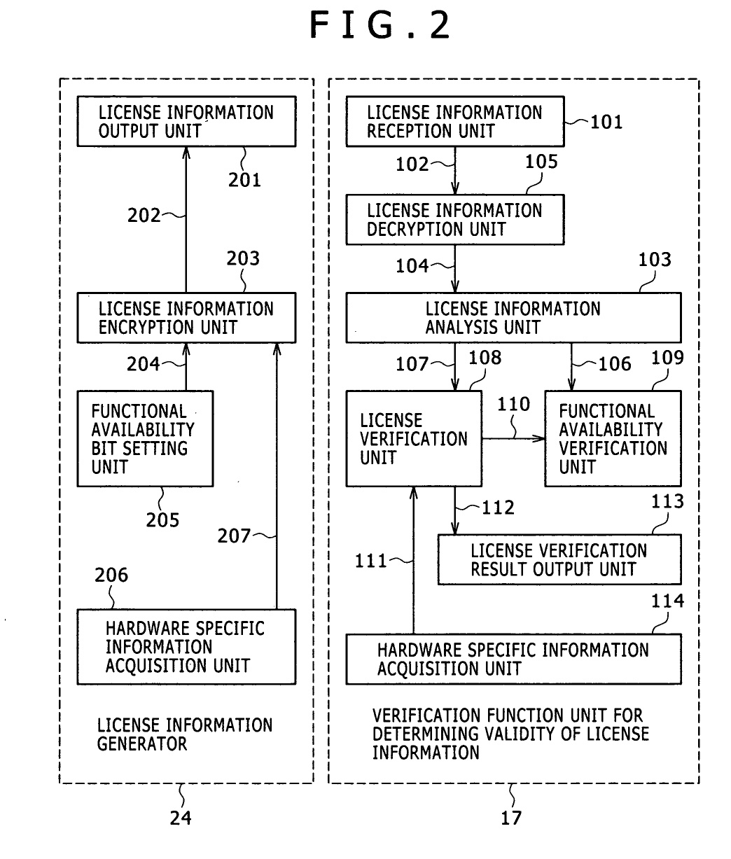

FIG. 1 is a diagram showing the placement of a device 22 running with embedded software such as a server, internal units constituting the device 22, and peripheral devices. FIG. 2 is a diagram showing the functional configuration of a verification function unit 17 of FIG. 1 for determining the validity of the license information, as well as the functional configuration of a license information generator 24 of FIG. 1.

In FIG. 1, the license information generator 24 acquires the hardware specific information from a specific information storage unit 21 provided within a hardware device 20, through an interface 23 for notifying the hardware specific information. Upon acquisition of the hardware specific information, the license information generator 24 generates license information based on the acquired hardware specific information. The generated license information is notified to a user through an interface 25 for notifying the license information.

The license information generator 24 includes, for example, a management PC for managing the production and shipping of the device 22 running with embedded software such as a server, or software to be executed by such a PC. In other words, the management PC acquires the hardware specific information stored in the hardware specific information storage unit 21 such as a memory, from the device 22 running with embedded software such as a server. Incidentally, the hardware specific information includes information relating to the device 22 running with embedded software, such as the serial number, manufacture name, and model number. Further, the memory which is the hardware specific information storage unit 21 includes, for example, ROM (Read Only Memory).

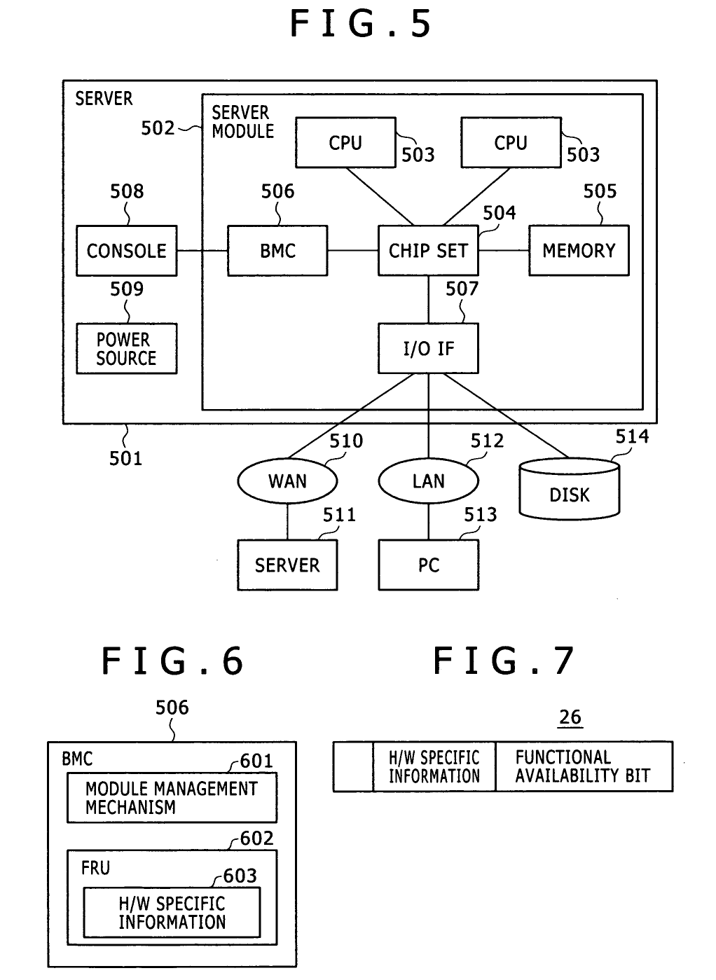

FIG. 5 is a block diagram of the configuration of a server device which is an example of the device running with embedded software according to the present invention.

The server device includes plural CPUs 503, a chip set 504, a memory 505, BMC (Board Management Controller) 506, I/O_IF 507, a console 508, and a power source 509. The plural CPUs 503 are connected to the memory 505, BMC 506, and I/O_IF 507 respectively through the chip set 504. The BMC 506 is connected to the console 508. The I/O_IF 507 is connected to a server 511 through WAN (for example, the Internet), to PC 513 through LAN 512, and to a disk 514, respectively.

FIG. 6 is a block diagram of the configuration of the BMC 506.

The BMC 506 is provided within a server module within a server enclosure. The BMC 506 includes a module management mechanism 601 for detecting anomalies in the server module, such as temperature anomaly and voltage anomaly. The module management mechanism 601 provides a function to maintain and manage the information necessary for hardware control. The existence of the BMC 506 is not recognized by the user, so that the confidentiality of the implementation can be ensured.

The BMC 506 includes FRU (Field Replacement Unit) 602 in which hardware specific information (such as the serial number) 603 is stored. The hardware specific information 603 stored in the FRU 602 can be set in the production process of the server module 502. Because not only the FRU 602 but also an interface for reading the information from the FRU 602 has its own specifications, the information can only be read from a specific firmware by a specific command. The user is not allowed to browse, alter, and change the information.

The user using the device 22 running with embedded software, such as the server, acquires license information 26 from the license information generator 24 through the interface 25, and inputs the acquired license information 26 into an embedded software storage unit 14 from the user terminal 11 through an interface 12. The embedded software storage unit 14 delivers the license information 26 to the verification function unit 17 for determining the validity of the license information.

The verification function unit 17 for determining the validity of the license information is connected through an interface 18 to the hardware specific information storage unit 21 such as, for example, the memory of the server. The hardware specific information storage unit 21 delivers the hardware specific information to the verification function unit 17 for determining the validity of the license information, through an interface 19 for delivering the hardware specific information.

The verification function unit 17 for determining the validity of the license information acquires the hardware specific information included in the license information 26. Then, the verification function unit 17 matches the acquired hardware specific information with the hardware specific information delivered from the hardware specific information storage unit 21. As a result of the matching, when the two pieces of information are matched, the verification function unit 17 determines that the license verification result is normal, and permits the use of the embedded software while notifying the user terminal 11 through an interface 16 for delivering the verification result of the license information, as well as through an interface 13 for outputting the verification result of the license information to the user terminal.

When the two pieces of information are not matched as a result of the matching, the verification function unit 17 determines that the license verification result is abnormal, and restricts the use of the embedded software while notifying the user terminal 11 through the interface 16 for delivering the verification result of the license information, as well as through the interface 13 for outputting the verification result of the license information to the user terminal.

Referring to FIGS. 2 and 7, a detailed description will be given of a specific example of the license information generator 24 and the verification function unit 17 for determining the validity of the license information, which are shown in FIG. 1.

As described above, the license information generator 24 of FIG. 2 typically includes a shipping management PC, or a program running on the PC. A license information encryption unit 203 receives the hardware specific information from a hardware specific information acquisition unit 206 through an interface 207 for delivering the hardware specific information. At the same time, the license information encryption unit 203 receives functional availability bit information from a functional availability bit setting unit 205 through an interface 204 for delivering the functional availability bit information. The license information encryption unit 203 combines the hardware specific information and the functional availability bit information, and encrypts the combined information. The encryption result is delivered, as the license information 26, to a license information output unit 201 through an interface 202 for delivering the license information.

Incidentally, the functional availability bit information is, for example, information of 32 bits that is stored in the functional availability bit setting unit 205 having a register, in which each bit indicates the availability of each of plural functions included in the software.

The verification function unit 17 of FIG. 2 for determining the validity of the license information can be configured, for example, as one of plural embedded software applications in the device 22 running with embedded software, namely, one of the firmware sets. In the verification function unit 17, the license information 26 input from a license information reception unit 101 is delivered to a license information decryption unit 105 through an interface 102 for delivering the license information. The license information decryption unit 105 decrypts the encrypted license information back to the plaintext, and delivers the result to a license information analysis unit 103 through an interface 104 for delivering the license information.

The license information analysis unit 103 analyzes the decrypted license information, and extracts the functional availability bit information. The extracted functional availability bit information is delivered to a functional availability verification unit 109 through an interface 106 for delivering the functional availability bit information. Further, the decrypted license information, particularly a portion corresponding to the hardware specific information, is delivered to a license verification unit 108 through an interface 107 for delivering the license information.

The license verification unit 108 acquires the hardware specific information from a hardware specific information acquisition unit 114 through an interface 111 for delivering the hardware specific information. The license verification unit 108 determines the validity of the license by matching the corresponding portion of the license with the hardware specific information. Then, the license verification unit 108 notifies the functional availability verification unit 109 of the verification result through an interface 110 for delivering the license verification result. At the same time, the license verification unit 108 notifies a license verification result output unit 113 of the verification result through an interface 112 for delivering the license verification result. The license verification result output unit 113 outputs the notified verification result.

When the result of the license verification in the license verification unit 108 is normal, the functional availability verification unit 109 permits the device 22 to use a relevant function corresponding to each bit of the functional availability bit information from the license information analysis unit 103. When the result of the license verification is abnormal, the functional availability verification unit 109 restricts the use of all the functions in the device 22.

The embedded software storage unit 14 of FIG. 3 includes a license receiving unit 301. The license receiving unit 301 receives the license information issued by a license issuing device 304 through a license reception line 302 via Internet 303.

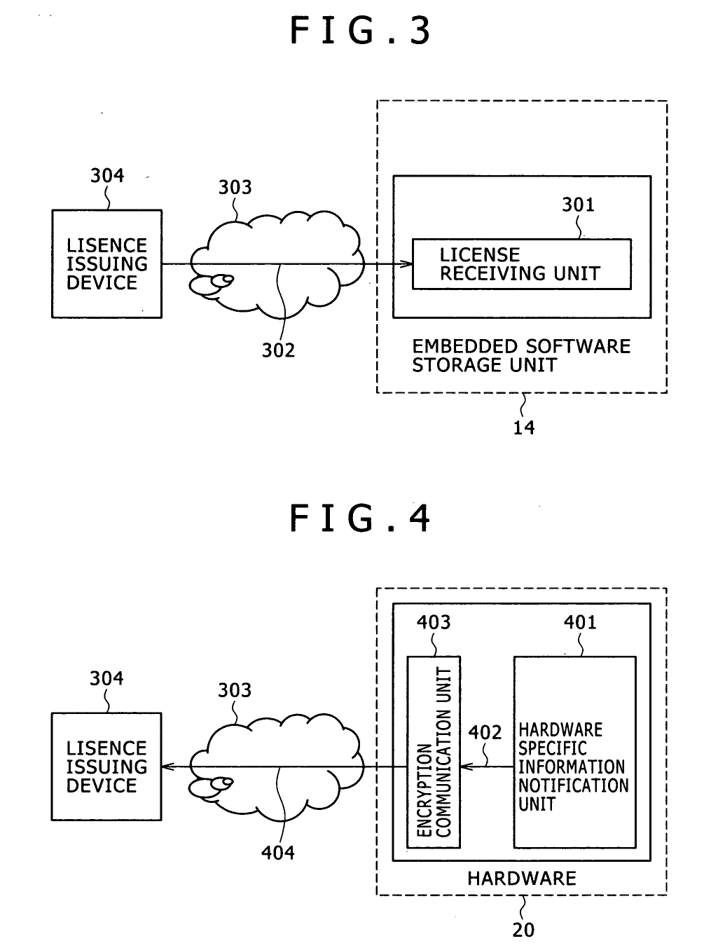

The hardware 20 of FIG. 4 includes a hardware specific information notification unit 401, from which the hardware specific information is transmitted to an encryption communication unit 403 through an interface 402 for delivering the hardware specific information. Then, the encrypted hardware specific information is notified to the license issuing device 304 through a hardware specific information notification line 404 via the Internet 303.

The user is provided with flexibility in reissuing a license by adding functionality so that the acquisition of the hardware specific information and the notification of the license information can be realized through the Internet.

The license information includes information for identifying the function that permits the license. When the server has a function A and a function B, it is possible to issue a license for the use of the function A but not for the function B. When the user requests the use of the function B, it is necessary to reissue a license. The license reissuance can be made by a method selected from either offline issuance by the PC or online issuance via the Internet.

Usually a license is reissued offline by the PC. However, the user uses online issuance via the Internet, for example, from overseas, which enables the user to perform a flexible maintenance operation.

As described in detail above, according to the present invention, it is possible for the device running with embedded software to prevent illegal use of the software.

What is claimed is:

1. A device running with embedded software comprising:
an information storage unit for storing hardware specific information; and
a verification function unit for determining the validity of license information;
wherein the verification function unit includes:
a license information reception unit for receiving the input of the license information;
a hardware specific information acquisition unit for acquiring the hardware specific information from the information storage unit; and
a first verification unit for determining the validity of the license by matching the acquired hardware specific information with the received license information.

2. The device running with embedded software according to claim 1,
wherein the license information includes the encrypted hardware specific information, and
the verification function unit includes a decryption unit for decrypting the encrypted hardware specific information.

3. The device running with embedded software according to claim 1,
wherein the license information includes bit information indicating the availability of a plurality of functions of the embedded software, and
the verification function unit includes a second verification unit for determining the availability of the plurality of functions based on the bit information.

4. The device running with embedded software according to claim 1, further comprising a license receiving unit for receiving the license information via the Internet.

5. The device running with embedded software according to claim 1, further comprising a hardware specific information notification unit for notifying a license information generator of the hardware specific information via the Internet.

6. A method for a server running with embedded software to verify the license of the embedded software, the method comprising the steps of:
inputting license information including hardware specific information from the outside;
acquiring the hardware specific information held by the server from an information storage unit provided within the server; and
determining the validity of the license, by matching the hardware specific information included in the license information input from the outside, with the hardware specific information acquired from the information storage unit provided within the server.

7. The method for verifying the embedded software license according to claim 6,
wherein the license information includes encrypted hardware specific information, and
the method further comprises the step of decrypting the encrypted hardware specific information included in the license information, after the input of the license information from the outside.

8. The method for verifying the embedded software license according to claim 6,
wherein the license information includes bit information indicating the availability of a plurality of functions of the embedded software, and
the method further comprises the step of permitting the use of a relevant function corresponding to the bit information, after the license is determined to be valid.

9. The method for verifying the embedded software license according to claim 6,
wherein the step of inputting the license information from the outside is a step of receiving the license information via the Internet.

10. The method for verifying the embedded software license according to claim 6,
wherein the method further comprises the step of notifying a license information generation server of the hardware specific information via the Internet.
